(19) United States
(12) Patent Application Publication
(10) Pub. No.: US 2008/0017400 A1
(43) Pub. Date: Jan. 24, 2008

(54) Element, Thin Film Transistor and Sensor Using the Same, and Method of Manufacturing Element

(75) Inventors: Hiroshi Yamamoto, Tokyo (JP); Kunji Shigeto, Saitama (JP); Kazuhito Tsukagoshi, Saitama (JP); Iwao Yagi, Kanagawa (JP); Reizo Kato, Tokyo (JP)

Correspondence Address: BIRCH STEWART KOLASCH & BIRCH, PO BOX 747, FALLS CHURCH, VA, 22040-0747, US

(73) Assignees: Riken, Wako-shi (JP); Japan Science and Technology Agency, Kawaguchi-shi (JP)

(21) Appl. No.: 11/587,129

(22) PCT Filed: Apr. 20, 2005
(86) PCT No.: PCT/JP05/07945

§ 371 Date: Aug. 21, 2007

(30) Foreign Application Priority Data
Apr. 20, 2004 (JP) 2004-123757

(51) Int. Cl. H01B 5/00; C25D 11/00; C25D 7/12

(52) U.S. Cl. 174/126.2; 205/157; 205/317

(57) ABSTRACT

Provided is an element which is formed of a conductor composed of a monocrystalline organic compound. Employed is an element including a pair of electrodes with a gap of 10 to 900 nm therebetween and a conductor composed of a monocrystalline organic compound disposed between the pair of electrodes.

### BACKGROUND OF THE INVENTION

1. Technical Field

The present invention relates to an element usable for a thin film transistor or a sensor, and a thin film transistor and a sensor using the element.

2. Background Art

In the past, a technique of depositing an electrode or an insulating layer on previously formed crystals was employed to apply a gate voltage to monocrystals of a molecular conductor (J. S. Brooks, Advanced Materials for Optics and Electronics, vol. 8, pp. 269-276 (1998)). However, the technique has a problem that the surface of the organic crystal is greatly damaged, thereby not fabricating an element having the original characteristic of the molecular conductor. This is because smooth junction between the crystal and the electrode or the insulating layer is necessary for the element using a gate electrode but is difficult to form.

In this situation, it is considered in S. F. Nelson et al., Appl. Phys. Lett, 72, 1854 (1998) that molecules such as pentacene or polymers such as polythiophene are deposited on a silicon substrate using a spin coating method to form an element, which is allowed to operate as a thin film transistor (FET) However, in this case, domains were formed in the element and the grain boundaries severely affected the element characteristics. In the molecular conductor, since the molecules are generally insoluble in a solvent and do not have malleability or volatility, at first, such techniques were not able to be applied in almost all cases.

On the other hand, as a method of educing a conductive material on an electrode by electrolysis, a method of electrolyzing gold to form a point contact is disclosed in V. Rajagopalan et al., Nano lett, 3, 851-855 (2003). However, in this case, the educed molecules were amorphous polycrystal and growth of monocrystal has been not known.

A method of electrolyzing phthalocyanine by AC current is disclosed in H. Hasegawa et al., Synthetic Metals, 135-136, 763-764 (2003). However, in this case, electrodes were not bridged.

That is, when an element is fabricated using a polycrystalline conductor, the junction between crystals causes a problem. That is, an unnecessary resistor is generated, a portion operating as a capacitor is generated, or a non-linear response such as a Schottky barrier is exhibited. The electrical characteristic of the grain boundary makes the original device characteristic of a monocrystal dull or denatured. Accordingly, it is considered that the original characteristics of the material can be sufficiently exhibited if the electrodes are joined through only a monocrystal.

However, as described above, electrodes have not been bridged using a monocrystal.

Here, the inventor eagerly studied the reason for not having been able to bridge the electrodes using a monocrystal.

First, as a result of study on an inorganic conductor which was considered as a conductor in the past, the inorganic conductor was not sufficient in practice since a very high temperature is necessary to allow the monocrystal to grow between electrodes.

Therefore, the inventor attempted to bridge electrodes using a monocrystal in which an organic material is used as a raw material. However, a monocrystal of a conductor composed of an organic compound has not been considered as being used for such an element and a test method or a handling method thereof was not clear in many cases. Of course, a method of fabricating a monocrystalline element using an organic material was not even predicted.

### SUMMARY OF THE INVENTION

The present invention is contrived to solve the above-mentioned problems. An object of the invention is to form a conductor composed of a monocrystalline organic compound between electrodes.

In this situation, as a result of the inventor's eager study, the above-mentioned object can be accomplished by the following means:

(1) An element including a pair of electrodes with a gap of 10 to 900 nm therebetween and a conductor composed of a monocrystalline organic compound disposed between the pair of electrodes.

(2) An element including a pair of electrodes and a conductor composed of a monocrystalline organic compound disposed between the electrodes, wherein the monocrystalline organic compound is formed by directly growing between the electrodes.

(3) The element according to (1) or (2), wherein the conductor consists of a single piece of monocrystal.

(4) The element according to any one of (1) to (3), wherein the conductor composed of the monocrystalline organic compound is a conductor obtained by forming a salt on the electrodes.

(5) The element according to (4), wherein the monocrystalline organic compound has an oxidation-reduction potential of 0.8V or less relative to an Ag/AgCl/CH₃CN electrode.

(5-2) The element according to (4) or (5), wherein the thickness of the electrodes is in the range of 5 to 20 nm.

(6) The element according to any one of (1) to (3), wherein the conductor composed of the monocrystalline organic compound is a conductor formed by electrolysis on the electrodes.

(6-2) The element according to (6), wherein the thickness of the electrodes is in the range of 150 to 250 nm.

(7) The element according to (6), wherein the monocrystalline organic compound contains sulfur.

(8) The element according to (6), wherein the monocrystalline organic compound is a ring compound.

(9) The element according to (6), wherein the monocrystalline organic compound is a conjugate organic polymer compound.

(10) The element according to (6), wherein the monocrystalline organic compound is a cation radical salt or an anion radical salt.

(11) The element according to (6), wherein the monocrystal line organic compound is one selected from the group consisting of a cation radical salt obtained by oxidizing a donor molecule, an anion radical salt obtained by reducing an acceptor molecule, an anion radical salt obtained by partially oxidizing an anion metal complex, and a single-component molecule obtained by oxidizing an anion metal complex until it is neutral.

(12) The element according to (11), wherein the monocrystalline organic compound is an anion radical salt obtained by reducing an acceptor molecule and a cation radical salt obtained by oxidizing a donor molecule.

(13) The element according to (6), wherein the monocrystalline organic compound has a tetrathiafulvalene skeleton.

(14) A thin film transistor having the element according to any one of (1) to (13).

(15) A sensor having the element according to any one of (1) to (13).

(16) A method of fabricating the element according to anyone of (1) to (5), the method including forming the conductor composed of a monocrystalline organic compound by forming a salt between the pair of electrodes.

(17) A method of fabricating the element according to any one of (1) to (5), wherein a salt is formed between the pair of electrodes out of a compound having an oxidation-reduction potential of 0.8V or less relative to an Ag/AgCl/CH₃CN electrode.

(18) The method of fabricating the element according to (16) or (17), wherein an electrode having a lamination structure formed by depositing an electrode material layer other than gold on a gold layer is used as the electrodes.

(19) A method of fabricating the element according to any one of (1) to (3) and (6) to (13), wherein the conductor composed of a monocrystalline organic compound is formed between the pair of electrodes by applying a voltage across the pair of electrodes.

(20) The method of fabricating the element according to (19), wherein the step of forming the conductor composed of a monocrystalline organic compound between the pair of electrodes by applying a voltage across the pair of electrodes is performed by immersing the pair of electrodes in an electrolyte solution and electrolyzing the electrolyte solution.

(21) A method of fabricating the element according to (1) to (3) and (6) to (13), the method comprising: depositing an electrode layer on a substrate, immersing the substrate on which the electrode layer is deposited in an electrolyte solution, and electrolyzing the electrolyte solution by applying a voltage across the electrode layer.

(22) The method of fabricating the element according to (21), wherein the substrate is a semiconductor substrate.

(23) The method of fabricating the element according to (21) or (22), wherein an insulating layer is formed on the electrode layer.

(24) The method of fabricating the element according to any one of (19) to (23), wherein the electrolyte solution is a solution including one selected from the group consisting of a donor molecule, an acceptor molecule, and an anion metal complex.

(25) The method of fabricating the element according to any one of (19) to (24), wherein both of the pair of electrodes are positive electrodes or negative electrodes.

### BRIEF DESCRIPTION OF THE DRAWINGS

FIG. 1 is a diagram illustrating the entire shape of a substrate before electrolysis in Example 1.

FIG. 2 is a diagram illustrating the entire shape of the substrate after the electrolysis in Example 1.

FIG. 3 is a partially enlarged view of FIG. 2.

FIG. 4 is a diagram illustrating a place where a circuit is cut by a laser beam in the substrate shown in FIG. 2.

FIG. 5 is a diagram illustrating the entire shape of a substrate before fabricating monocrystals in Example 2.

FIG. 6 is a diagram illustrating the entire shape of the substrate after fabricating monocrystals in Example 2.

FIG. 7 is a partially enlarged view of the monocrystals fabricated in Example 2.

FIG. 8 is a diagram illustrating a place where a circuit fabricated in Example 2 is cut by a laser beam.

### DESCRIPTION OF THE PREFERRED EMBODIMENTS

Hereinafter, the present invention will be described in detail. In the following description, “˜” is used to have a meaning including the numerals described before and after it as the upper limit value and the lower limit value.

First, a monocrystalline organic compound according to the invention will be described. As the monocrystalline organic compound according to the invention, widely known organic compounds can be used if only they are compounds having conductivity. Examples thereof can include the followings.

(1) Organic Compound Containing Sulfur

Organic compounds containing sulfur can be employed and compounds having a hetero ring skeleton containing sulfur can be used preferably. Compounds including a hetero ring having a carbon number of 3˜10 (preferably a carbon number of 4˜6) containing one or more sulfur and a condensed ring in which the hetero ring and/or two or more other rings having a carbon number of 3˜10 (preferably a carbon number of 4˜6) are condensed can be used more preferably. The number of condensed rings is preferably in the range of 2˜15, more preferably in the range of 2˜10, still more preferably in the range of 2˜5, and still more preferably in the range of 2˜4. The condensed rings may be bonded to each other through a single bond, a double bond, a triple bond, or a connection group. Examples of the connection group can include two-valence or more metal atoms, —CH₂—, —O—, —S—, or —N—, and groups obtained by combination of two or more thereof. Examples of the hetero ring forming the condensed ring can include rings having a thiophene skeleton, a dithiophene skeleton, a thiazole skeleton, and a thiane skeleton and/or a dithiane skeleton. The compounds containing sulfur according to the invention may have a proper substituent group without departing from the gist of the invention.

Preferable examples of the organic compound containing sulfur according to the invention can include compounds having a tetrathiafulvalene (TTF) skeleton or compounds having a dithiophene metal skeleton(M(dmit)₂) (wherein M is Ni, Pd, or Pt). As the compounds having the tetrathiafulvalene (TTF) skeleton, tetrathiafulvalene (TTF), ethylendithio-tetrathiafulvalene (EDT-TTF), and bis(ethylendithio)-tetrathiafulvalene (BEDT-TTF) can be used preferably and ethylendithio-tetrathiafulvalene (EDT-TTF) can be used more preferably.

(2) Ring Compound

Ring compounds can be employed, which preferably includes hetero ring compounds. As the ring compounds, compounds having a condensed ring in which two or more ring compounds having a carbon number of 3˜10 (preferably a carbon number of 4˜6) are condensed can be used preferably. The number of condensed rings is preferably in the range of 2˜15, more preferably in the range of 2˜10, still more preferably in the range of 2˜5, and still further preferably in the range of 2˜4. The condensed rings maybe bonded to each other through a single bond, a double bond, a triple bond, or a connection group. Examples of the connection group can include two-valence or more metal atoms, —CH₂—, —O—, —S—, and —N—, and groups obtained by combination of two or more thereof. Ring-type hydrocarbons and/or hetero rings are preferably used as the compound forming the condensed ring. The ring compounds according to the invention may have a proper substituent group without departing from the gist of the invention.

Preferable examples of the ring compound according to the invention can include compounds having a benzene skeleton, compounds having a quinoide skeleton, compounds having a triphenylene skeleton, compounds having a perylene skeleton, compounds having a rubicene skeleton, compounds having a coronene skeleton, compounds having an ovalene skeleton, and compounds having a hetero ring skeleton. More preferable examples thereof can include compounds having a quinoide skeleton, compounds having a perylene skeleton, and compounds having a hetero ring skeleton.

Examples of the compounds having a quinoide skeleton can include 7,7,8,8-tetracyanoquinondimethane (TCNQ) and dicyanoquinondiimine (DCNQI).

In addition, compounds which are exemplified in the above (1) and correspond to the ring compounds can be preferably used. (3) Conjugate Organic Polymer

Conjugate organic polymers can be used and examples thereof can include polyacetylene, polythiophene, poly(3-methythiophene), polyisothianaphthene, poly(p-phenylene sulfid), poly(p-phenylene oxide), polyaniline, poly(p-phenylene vinylene), poly(thiophene vinylene), polyperinaphthalene, nickel phthalocyanine, polydiacetine, polypyrrol, polyparaphenylene, polyparaphenylene sulfide, and polyacrylate.

In addition, compounds which are exemplified in the above (1) or (2) and correspond to the conjugate organic polymers can be preferably used.

(4) Cation Radical Salt

A cation radical salt according to the invention is preferably obtained by oxidizing a donor molecule. The donor molecule is not particularly limited so long as it does not depart from the gist of the invention. However, preferable examples thereof can include compounds having a tetrathiafulvalene (TTF) skeleton, compounds having a perylene skeleton, and compounds having a tetrathiapentalene (TTP) skeleton and more preferable examples thereof can include compounds having a tetrathiafulvalene (TTF) skeleton and compounds having a perylene skeleton.

Compounds which are exemplified in the above (1) to (3) and correspond to the cation radical salts can be preferably used.

(5) Anion Radical Salt

A conductor composed of a monocrystalline organic compound can be obtained by an anion radical salt. The anion radical salt according to the invention can be obtained preferably by reducing an acceptor molecule or partially oxidizing an anion metal complex. Among them, the anion radical salt can be obtained more preferably by reducing an acceptor molecule.

The acceptor molecule according to the invention is not particularly limited so long as it does not depart from the gist of the invention, but preferable examples thereof can include a variety of substituted 7,7,8,8-tetracyanoquinondimethane (TCNQ), dicyanoquinondiimine (DCNQI), and a variety of substituted quinones (chloranil, etc.) and more preferable examples thereof can include a variety of substituted 7,7,8,8-tetracyanoquinondimethane (TCNQ) and a variety of substituted dicyanoquinondiimine (DCNQI).

On the other hand, the anion metal complex is not particularly limited so long as it does not depart from the gist of the invention, but preferable example thereof can include compounds having a dithiolene metal skeleton (M(mnt)₂) (wherein M is Ni, Pd, or Pt) (M(dmit)₂) (wherein M is Ni, Pd, or Pt)and a phthalocyanine complex and more preferable example thereof can include compounds having a dithiolene metal skeleton(M(dmit)₂) (wherein M is Ni, Pd, or Pt).

Compounds which are exemplified in the above (1) to (3) and correspond to the anion radical salt can be preferably used. (6) Single-component Molecular Conductor obtained by oxidizing Anion Metal Complex until it is neutral

A single-component molecular conductor obtained by oxidizing an anion metal complex until it is neutral can be employed. Here, the usable anion metal complex is not particularly limited so long as it can become a single-component molecular conductor by oxidizing a complex until it is neutral and widely known complexes can be used. A specific example thereof can include Ni(tmdt)₂.

Compounds which are exemplified in the above (1) to (5) and correspond to the single-component molecular conductor obtained by oxidizing an anion metal complex until it is neutral can be preferably used.

The conductor composed of a monocrystalline organic compound according to the invention means that a composition exhibiting conductivity is composed of a monocrystalline organic compound, but does not exclude that another component (for example, materials, impurities and the like used for fabricating a conductor) is included therein without departing from the gist of the invention.

Preferable compounds can be properly selected from the compounds of (1) to (6), depending upon the applications and the like. For example, when it is used in a thin film transistor or a sensor, the compounds of (1) and (2) having a relatively high resistance can be preferably used. On the other hand, when it is used for a wire material, the compound of (3) having a relatively low resistance can be preferably-used.

The material of the electrode according to the invention is not particularly limited, but a variety of materials can be used so long as they do not depart from the spirit of the invention. Preferable examples thereof can include gold (Au), titanium (Ti), chromium (Cr), tantalum (Ta), copper (Cu), aluminum (Al), molybdenum (Mo), tungsten (W), nickel (Ni), palladium (Pd), platinum (Pt), silver (Ag), and tin (Sn). In addition, conductive polymers such as polythiophene (specifically, polyethylene dioxythiophene), polystyrensulfonate, polyaniline, polypyridine, polyphenylene vinylene doped with pyrrole and iodine, and polyethylene dioxythiophene/polystyrene sulfonate compolymer can be used. Furthermore, combinations thereof can be used. For example, combinations (for example, lamination structure) of gold (Au) and other metals (preferably titanium (Ti), nickel (Ni), and copper (Cu)) can be used. The gap between the electrodes is preferably in the range of 10 to 900 nm, more preferably in the range of 50 to 500 nm, and still more preferably in the range of 50 to 200 nm.

The conductor composed of a monocrystalline organic compound according to the invention is allowed to directly grow between the electrodes formed on an electrode layer after the electrode layer is formed on a substrate. Here, “directly grow” means that monocrystals are allowed to grow between the electrodes, not that monocrystals are formed and then the monocrystals are joined to electrodes. By using such a means, it is possible to smooth the junction between the monocrystals and the electrodes. The growth of a conductor composed of a monocrystalline organic compound can be carried out by forming a salt using a solution including an organic compound for forming the monocrystals between the electrodes or by electrolyzing the electrolyte solution.

First, the method of forming the salt using the solution including an organic compound for forming the monocrystals between the electrodes will be described. Such a solution is not particularly limited so long as it can form a monocrystalline salt between the electrodes by immersing the electrodes in the solution or dropping the solution between the electrodes and then drying the electrodes. Specifically, compounds having an oxidation-reduction potential of 0.8V or less relative to an Ag/AgCl/CH₃CN electrode can be preferably used, compounds having an oxidation-reduction potential of 0.5V or less relative to an Ag/AgCl/CH₃CN electrode can be more preferably used, acceptor molecules can be still more preferably used, and a derivative of DCNQI or TCNQ is most preferably used. Of course, compounds which are the above (1) to (6) and can form the salt between the electrodes are preferably used.

The concentration of the organic compound in which the electrodes are immersed is preferably in the range of 0.1 to 20 mmol/L and more preferably in the range of 0.5 to 5 mmol/L. By setting the range of concentration as described above, the monocrystals can properly grow between the electrodes. A solvent dissolving the organic compound is not particularly limited so long as it does not depart from the gist of the invention, but preferable examples thereof can include acetonitrile, acetone, chloroform, and benzonitrile. When the salt is formed by immersing the electrodes (and the substrate on which the electrodes are formed) in the solution, the immersing time is preferably in the range of 10 to 120 seconds. By setting the range of time as described above, it is possible to allow proper monocrystals to grow between the electrodes.

When the monocrystals are formed by forming the salt, the thickness of the electrodes is preferably in the range of 5 to 20 nm. By setting the range of thickness of the electrodes as described above, it is possible to allow crystals to more properly grow between the electrodes. When the monocrystals are formed by forming the salt, it is preferable that the electrodes having a lamination structure in which an electrode material layer other than gold is formed on a gold layer. By using such the electrodes, it is possible to effectively avoid electrical non-connection due to dissolution of the electrodes. In this case, the above-mentioned materials of the electrodes can be preferably used as the electrode materials laminated on the gold layer.

On the other hand, when the fabrication is carried out by electrolyzing an electrolyte solution, the electrolyte solution is preferably a solution including a solution of donor molecules, acceptor molecules, and anion metal complexes. Of course, compounds which are the above (1) to (6) and can form the monocrystals by electrolysis can be preferably used. The solvent used for the electrolyte solution is not particularly limited so long as it does not depart from the gist of the invention, but preferable examples thereof can include ethanol, methanol, chlorobenzene, dichloromethane, and mixtures thereof. The electrolysis can be performed by applying a voltage across the electrodes. The voltage applied for the electrolysis is preferably in the range of 750 to 1100 mV. In the electrodes, it is more preferable that crystals are allowed between the positive electrode and the positive electrode or between the negative electrode and the negative electrode than that crystals growing from the positive electrode (or negative electrode) are joined to the negative electrode (or positive electrode). That is, for example, by forming electrodes on the silicon substrate (of which the surface is made of SiO₂) and performing the electrolysis into the electrolyte solution using the electrode as the positive electrode, the monocrystals composed of an organic compound grows so as to bridge the electrodes. By using such a means, it is possible to more effectively prevent crystals from being collected too densely, thereby allowing the monocrystals to more smoothly grow. It is preferable that a gate electrode is used as the opposite-polarity electrode at the time of electrolysis. By using the gate electrode as the opposite-polarity electrode, it is possible to allow the monocrystals to grow more uniformly. When the monocrystals are formed by electrolysis, the thickness of the electrodes is preferably in the range of 150 to 250 nm. By setting the thickness of the electrodes as described above, it is possible to easily bridge the electrodes, thereby allowing the monocrystals to easily grow.

When single crystals are formed by electrolysis, an insulating layer may be formed on the electrodes. By forming the insulating layer, it is desirable to exclude current flowing in the crystals disposed on the side surfaces of the electrodes and not serving as the conductor. The thickness of the insulating layer is preferably in the range of 15 to 25 nm. The insulating layer can be made of a variety of materials so long as it does not depart from the spirit of the invention. For example, inorganic materials such as silicon oxide, silicon nitride, aluminum oxide, titanium oxide, and calcium fluoride, polymer materials such as acryl resin, epoxy resin, polyimide, and Teflon (registered trademark), and self-organizing molecular films such as aminopropyl ethoxysilane can be preferably used.

When a substrate is provided in the element according to the invention, the substrate is not particularly limited, and well known substrates can be widely used. Examples thereof can include an insulating substrate and a semiconductor substrate.

The insulating substrate can be made of, for example, insulating resin such as silicon oxide, silicon nitride, aluminum oxide, titanium oxide, calcium fluoride, acryl resin, and epoxy resin, polyimide, Teflon, and the like.

The semiconductor substrate can be made of, for example, silicon, germanium, gallium arsenide, indium phosphide, and silicon carbide, and preferably silicon. The surface of the substrate is preferably flat.

Since the element according to the invention can be fabricated on the semiconductor substrate, a gate voltage can be applied thereto. As a result, it is possible to fabricate a thin film transistor.

In the element according to the invention, by burying agate electrode under the substrate, it is possible to fabricate the element to which a gate voltage can be applied. The material of the gate electrode is not particularly limited, and the materials used for such a type of transistors in the past can be widely used. Examples thereof can include Al, Cu, Ti, polysilicon, silicide, and organic conductive material. The gate insulating layer can be formed of, for example, inorganic insulating materials such as SiO₂ and SiN or an organic material such as polyimide and polyacrylonitrile.

In this way, the element according to the invention can be used for a thin film transistor. The substrate and the insulating layer can employ the above-mentioned materials.

### EXAMPLES

Hereinafter, the invention will be described in more details with reference to examples. Materials, amounts thereof, ratios, processing details, processing procedures, and the like described in the following examples can be properly changed without departing from the gist of the invention. Accordingly, the scope of the invention is not limited to the specific examples described below.

### Example 1

1. Fabrication of Electrode Layer

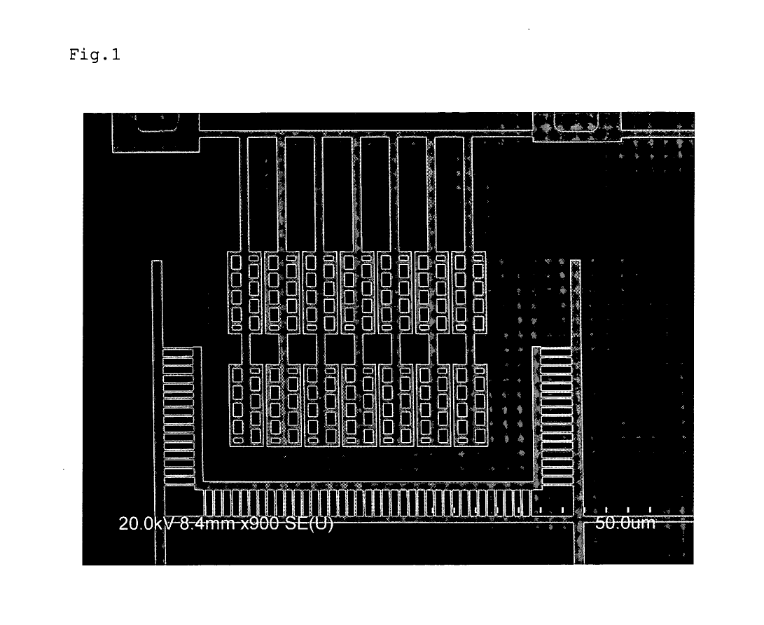

A positive type resist (ZEP) was applied to a silicon substrate (made by Furuuchi Chemical Corporation) of which the surface is coated with an oxide film and a circuit shown in FIG. 1 was drawn thereon using an electron beam lithography apparatus (Elionix 7300). The resultant structure was developed with pentyl acetate and then a titanium layer with 50 Å, a gold layer with 1500 Å, and a silicon dioxide layer with 20 Å were deposited thereon. A liftoff process was performed thereto with 2-butanone. In this way, the electrode layer shown in FIG. 1 was fabricated.

2. Adjustment of Electrolyte Solution

12 mg of EDT-TTF produced using the method described in Chem. Lett, Vol. 1989, p 781, 20 mg of tetraphenyl phosphonium bromide (Tokyo Chemical Industry T1069), 80 mg of tetraiodoethylene (TIE) (Aldrich 31824-8), and 2 ml of methanol were added to 18 ml of chlorobenzene, were agitated well, and then were left alone a night.

3. Fabrication of Monocrystal using Electrolysis

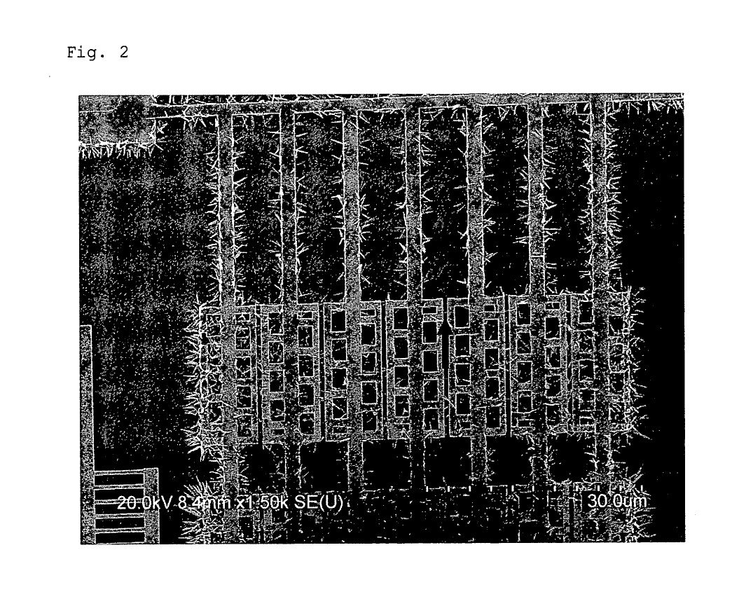

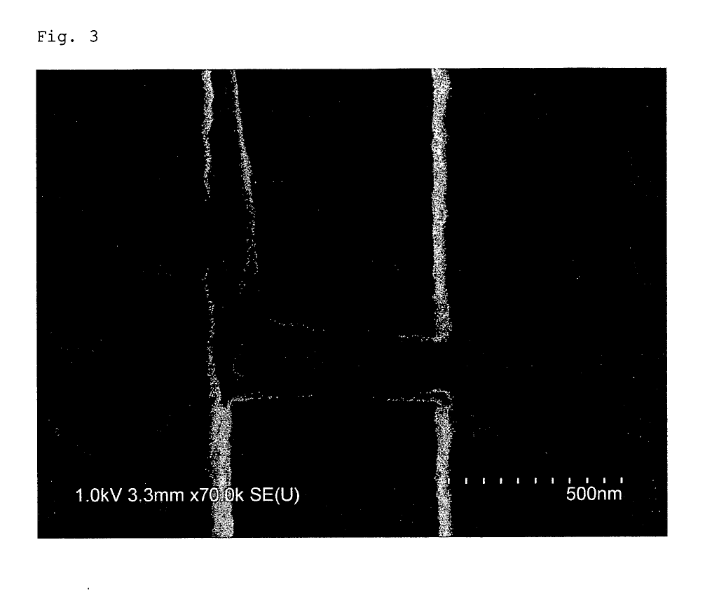

2 ml of the electrolyte solution was put into a glass petri dish and the silicon substrate fabricated in 1 was immersed in the solution. A power source was connected to a gold pad on the substrate using a prober (Kyowariken K-157MP). The electrodes shown in FIG. 1 were disposed so that a concave electrode shown below serves as a negative electrode and a skewer-shaped electrode shown above serves as a positive electrode. In this state, an electrolysis process was performed for 1 minute by applying a voltage of 800 mV thereto while monitoring current. Thereafter, the substrate was rapidly taken out and the remaining solution was removed. When the substrate having been sufficiently dried was observed using an electron microscope, a plurality of small monocrystals of (EDT-TTF)₄Br₃(TIE)₅ was created as shown in FIG. 2. FIG. 3 is an enlarged photograph illustrating the portion indicated by an arrow in FIG. 2 and it could be confirmed from the photograph that monocrystals firmly bridge the electrodes.

4. Check of Electrical Connection

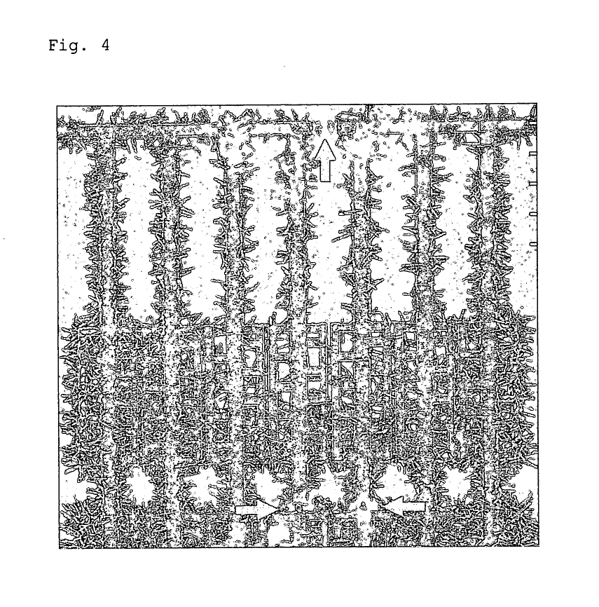

It was confirmed that current of about 50 nA flows when burning off the portion indicated by the arrow in FIG. 4 and applying a bias voltage of 1V across both the electrodes.

### Example 2

1. Fabrication of Silicon Substrate

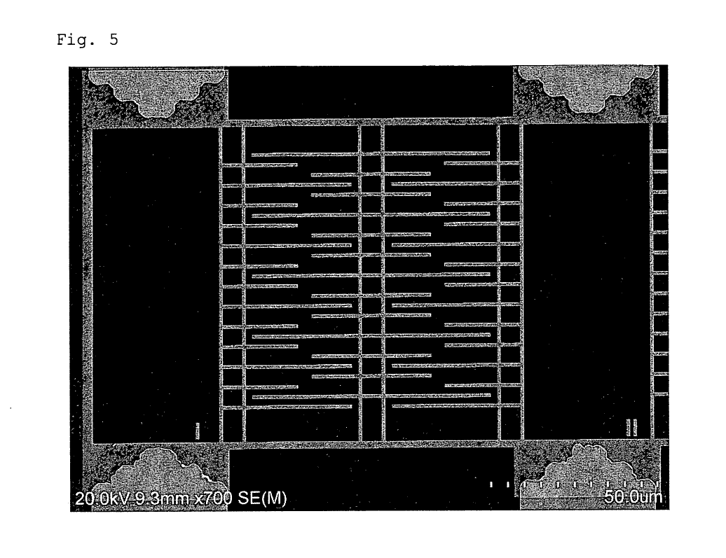

A resist (PMMA/MMA) was applied to a silicon substrate of which the surface is coated with an oxide film and a circuit shown in FIG. 5 was drawn thereon using an electron beam lithography apparatus (Elionix 7300). The resultant structure was developed and then a titanium layer with 50 Å, a gold layer with 150 Å, and a copper layer with 100 Å were deposited thereon. A liftoff process was performed thereto with acetone. In this way, the electrode layer shown in FIG. 5 was fabricated.

2. Adjustment of Solution

15 mg of dimethyl-N,N′-dicyanoquinondimine (DMe-DCNQI) (made of Aldrich Corporation) was added to 20 ml of nitrile acetate and then was agitated well.

3. Fabrication of Monocrystal

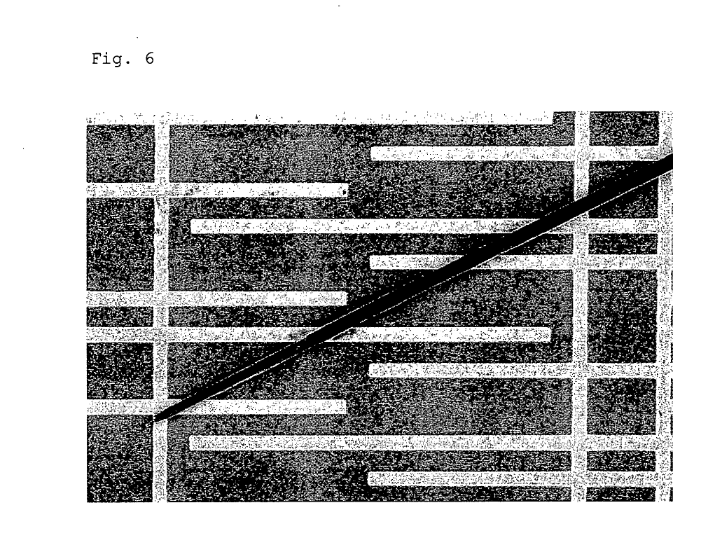

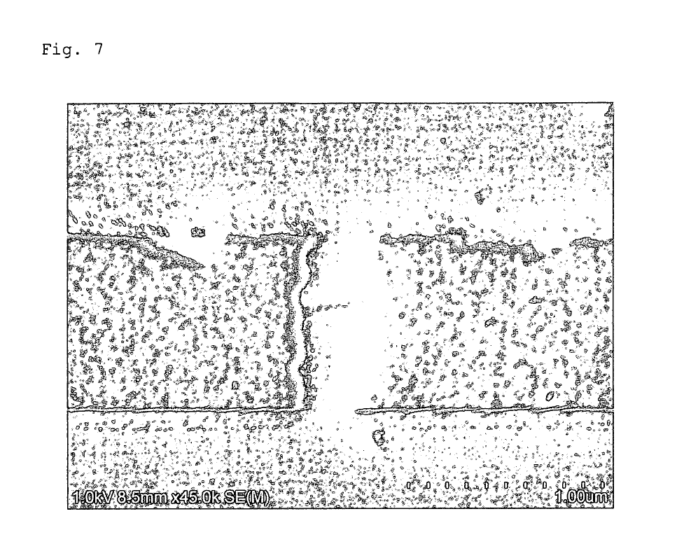

2 ml of the prepared solution was put into a glass petri dish and the silicon substrate fabricated in 1 was immersed in the solution for 30 seconds. Since it can be observed using an electron microscope that fine crystals grow on the substrate, the substrate was taken out when crystal grows with a proper density and then was dried. It was confirmed that monocrystals were created as shown in FIG. 6. FIG. 7 is an enlarged photograph of FIG. 6 and it could be confirmed from the photograph that monocrystals firmly bridged the electrodes.

4. Check of Electrical Connection

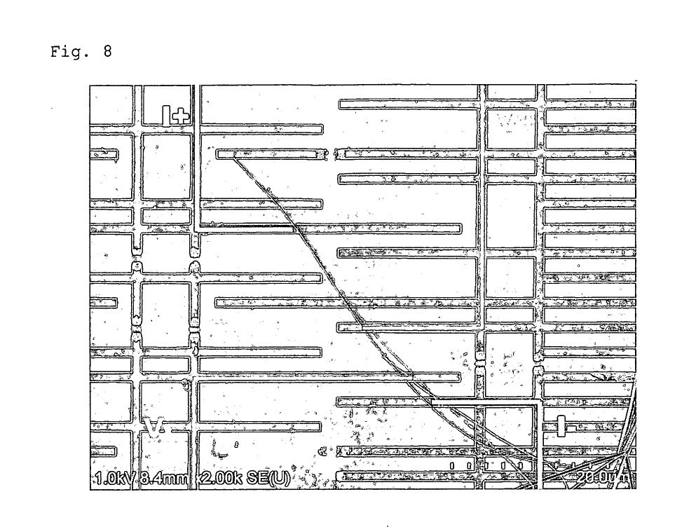

It was confirmed that current flows when properly burning off the circuit fabricated above using a laser beam and checking the electrical connection thereof. For example, when fabricating the four-terminal circuit shown in FIG. 8 and measuring the resistance values thereof, the resistance of the crystals was about 5 kΩ and the contact resistance with the electrode was about 1 kΩ.

### INDUSTRIAL APPLICABILITY

In the present invention, it was possible to succeed in fabricating monocrystals composed of an organic compound and to accomplish the electrical connection between the electrodes. In the past, elements formed of a conductor other than conductors having organic compounds or polycrystalline elements were known, but the element including the conductor composed of a monocrystalline organic compound as in the invention was not known at all. No test method was suggested for the conductor composed of monocrystalline organic compounds.

However, the inventor completed such an element through his energetic study, which is very great.

As described later, in the element according to the invention, since conductivity can be measured using one monocrystal, it is possible to prevent unbalance between elements. As a result, it is possible to further enhance operational performance.

In the method according to the invention, since the element can be fabricated on a silicon substrate and the like, as well as on a glass substrate, it is possible to fabricate a circuit including a gate electrode using a molecular conductor.

In the conductor composed of a monocrystal organic compound, since a constituent element is a “molecule”, functional groups having a variety of functions can be introduced and we can expect characteristics different from inorganic devices of the known inorganic elements are exhibited. Specifically, since an element is based on a monocrystal having a very clear structure, it is possible to accomplish highly sensitive and precise characteristics of an element and to accomplish applications to a very large range of fields.

In the method according to the invention, a monocrystal can be created directly on an electrode. Accordingly, since the monocrystal grows along the surface shape of the silicon substrate, it is possible to form a junction with a highly planarity by only planarizing the surface of the silicon substrate, compared with the known technique of junction an insulating film using a spattering method. Therefore, it is possible to use a conductor composed of an organic compound for an element without being affected by grain boundaries.

The element according to the invention can be used for a thin film transistor having a high-speed response characteristic or a high-sensitivity sensor reacting to light, humidity, or pH. By employing an element in which (preferably 1000 or more) monocrystals are arranged in parallel, it is possible to embody a sensor capable of sensing a very weak signal.

1-25. (canceled)

26. An element including a pair of electrodes with a gap of 10 to 900 nm therebetween and a conductor composed of a monocrystalline organic compound disposed between the pair of electrodes.

27. An element including a pair of electrodes and a conductor composed of a monocrystalline organic compound disposed between the electrodes, wherein the monocrystalline organic compound is formed by directly growing between the electrodes.

28. The element according to claim 26, wherein the conductor consists of a single piece of monocrystal.

29. The element according to claim 26, wherein the conductor composed of the monocrystalline organic compound is a conductor obtained by forming a salt on the electrodes.

30. The element according to claim 29, wherein an organic molecule constituting the monocrystalline organic compound has an oxidation-reduction potential of 0.8V or less relative to an Ag/AgCl/CH₃CN electrode.

31. The element according to claim 26, wherein the conductor composed of the monocrystalline organic compound is a conductor formed by electrolysis on the electrodes.

32. The element according to claim 31, wherein the monocrystalline organic compound contains sulfur.

33. The element according to claim 31, wherein the monocrystalline organic compound is a ring compound.

34. The element according to claim 31, wherein the monocrystalline organic compound is a conjugate organic polymer compound.

35. The element according to claim 31, wherein the monocrystalline organic compound is a cation radical salt or an anion radical salt.

36. The element according to claim 31, wherein the monocrystalline organic compound is one selected from the group consisting of a cation radical salt obtained by oxidizing a donor molecule, an anion radical salt obtained by reducing an acceptor molecule, an anion radical salt obtained by partially oxidizing an anion metal complex, and a single-component molecule obtained by oxidizing an anion metal complex until it is neutral.

37. The element according to claim 36, wherein the monocrystalline organic compound is an anion radical salt obtained by reducing an acceptor molecule and a cation radical salt obtained by oxidizing a donor molecule.

38. The element according to claim 31, wherein the monocrystalline organic compound has a tetrathiafulvalene skeleton.

39. A thin film transistor having the element according to claim 26.

40. A sensor having the element according to claim 26.

41. A method of fabricating the element according to claim 26, wherein including forming the conductor composed of a monocrystalline organic compound between the electrodes.

42. The method according to claim 41, wherein the conductor composed of a monocrystalline organic compound is formed by forming a salt between the pair of electrodes.

43. The method according to claim 41, wherein a salt is formed between the pair of electrodes out of a compound having an oxidation-reduction potential of 0.8V or less relative to an Ag/AgCl/CH₃CN electrode.

44. The method according to claim 41, wherein an electrode having a lamination structure formed by depositing an electrode material layer other than gold on a gold layer is used as the electrodes.

45. The method according to claim 41, wherein the conductor composed of a monocrystalline organic compound is formed between the pair of electrodes by applying a voltage across the pair of electrodes.

46. The method according to claim 45, wherein the forming of the conductor composed of a monocrystalline organic compound between the pair of electrodes by applying a voltage across the pair of electrodes is performed by immersing the pair of electrodes in an electrolyte solution and electrolyzing the electrolyte solution.

47. The method according to claim 41, wherein the method comprising:
depositing an electrode layer on a substrate, immersing the substrate on which the electrode layer is deposited in an electrolyte solution, and electrolyzing the electrolyte solution by applying a voltage across the electrode layer.

48. The method according to claim 47, wherein the substrate is a semiconductor substrate.

49. The method according to claim 47, wherein an insulating layer is formed on the electrode layer.

50. The method according to claim 46, wherein the electrolyte solution is a solution including one selected from the group consisting of a donor molecule, an acceptor molecule, and an anion metal complex.

51. A method according to claim 45, wherein both of the pair of electrodes are positive electrodes or negative electrodes.
